(19) United States
(12) Patent Application Publication
(10) Pub. No.: US 2011/0206158 A1
(43) Pub. Date: Aug. 25, 2011

(54) TRANSMITTER AND METHOD FOR TRANSMITTING MULTIPLE INPUT MULTIPLE OUTPUT AND RECEIVER AND METHOD FOR RECEIVING MULTIPLE INPUT MULTIPLE OUTPUT

(75) Inventors: Seong Rag KIM, Daejeon (KR); Seok Ho Won, Daejeon (KR); Jung-Im Kim, Daejeon (KR)

(73) Assignee: ELECTRONICS AND TELECOMMUNICATIONS RESEARCH INSTITUTE, Daejeon (KR)

(21) Appl. No.: 13/034,228

(22) Filed: Feb. 24, 2011

(30) Foreign Application Priority Data
Feb. 25, 2010 (KR) 10-2010-0017209
Feb. 26, 2010 (KR) 10-2010-0017695
Feb. 23, 2011 (KR) 10-2011-0015887

(51) Int. Cl. H04L 27/04; H04L 27/06

(52) U.S. Cl. 375/295; 375/340

(57) ABSTRACT

A transmitter that transmits data using a multiple antenna includes a multiple description coder that generates a plurality of descriptions by performing multiple description coding of the data, and a multiple input multi output (MIMO) transmitting unit that performs channel coding of the plurality of descriptions and that transmits a description in which channel coding is performed through the multiple antenna.

### CROSS-REFERENCE TO RELATED APPLICATION

This application claims priority to and the benefit of Korean Patent Application No. 10-2010-0017695, 10-2010-0017209 and 10-2011-0015887 filed in the Korean Intellectual Property Office on Feb. 26, 2010, Feb. 25, 2010 and Feb. 23, 2011, the entire contents of which are incorporated herein by reference.

### BACKGROUND OF THE INVENTION

(a) Field of the Invention

The present invention relates to a transmitter and method for transmitting multiple input multiple output, and a receiver and method for receiving multiple input multiple output.

(b) Description of the Related Art

A mobile broadcasting system includes a transmitter that transmits image information and a receiver that receives and reproduces the image information. The transmitter and the receiver may be a multiple input multiple output (MIMO) device that transmits/receives image information through a multiple antenna. A channel capacity of the MIMO device is determined by the small number of the numbers of transmitting and receiving antennas. Therefore, the receiver notifies the transmitter of the number of antennas thereof and receives a signal corresponding to a receiving ability of the receiver. However, the transmitter that broadcasts image information does not transmit a signal in consideration of only any one receiver. Therefore, the receiver may not obtain image information according to wireless environment or a receiving ability thereof. Particularly, when the transmitter transmits different information through a plurality of transmitting antennas, the receiver having receiving antennas of the number smaller than that of the transmitting antennas may not receive the information due to signal interference between antennas. In this way, because a plurality of receivers receive a signal in different wireless environment and have different reception ability, it is difficult that the transmitter provides an optimal service to all receivers.

### SUMMARY OF THE INVENTION

The present invention has been made in an effort to provide a transmitter and method of transmitting MIMO having advantages of transmitting MIMO by performing multiple description coding of data, and a receiver and method for receiving MIMO having advantages of decoding data in which multiple description coding is performed regardless of the number of antennas of receivers.

An exemplary embodiment of the present invention provides a transmitter that transmits data using a multiple antenna, the transmitter including: a multiple description coder that generates a plurality of descriptions by performing multiple description coding (MDC) of the data; and a MIMO transmitting unit that performs channel coding of the plurality of descriptions and that transmits the plurality of descriptions in which channel coding is performed through the multiple antenna.

The multiple description coder may form the data into the plurality of descriptions including related information.

The MIMO transmitting unit may include a serial to parallel converter that forms the plurality of descriptions into a plurality of packets and that outputs the plurality of packets in parallel; a plurality of channel encoders that correspond to the plurality of packets, respectively, and that generate a plurality of first transmission information by performing channel coding of each of the plurality of packets; a parallel to serial converter that converts the plurality of first transmission information to a plurality of second transmission information corresponding to the multiple antenna, respectively, based on the number of the antennas included in the multiple antenna; and the multiple antenna that transmits the plurality of second transmission information.

The serial to parallel converter may determine the number of the packets based on the plurality of descriptions and information of the channel encoder.

The parallel to serial converter may align in series the plurality of first transmission information and then generate the plurality of second transmission information corresponding to the multiple antenna based on the plurality of first transmission information that is aligned in series.

The transmitter may further include a plurality of interleavers that interleave the plurality of first transmission information, respectively, before converting the plurality of first transmission information to the plurality of second transmission information.

Another embodiment of the present invention provides a receiver that receives a signal that is transmitted from a transmitter using at least one antenna, the receiver including: a channel estimator that estimates a channel corresponding to the at least one antenna based on a received signal; a first decoder that generates a plurality of first decoding information by performing MIMO decoding of an input signal in which feedback information is applied to the received signal based on a channel estimating value; a plurality of second decoders that perform channel decoding of the plurality of first decoding information, respectively, and that repeat a process that generates the feedback information with a result of the channel decoding by one or more times and that then generate a plurality of second decoding information by performing channel decoding of the plurality of first decoding information, respectively; and a third decoder that performs multiple description decoding of the plurality of second decoding information.

The first decoder may determine the number of the plurality of first decoding information based on the number of descriptions that are included in the received signal.

The second decoder may include a deinterleaver that generates a deinterleaved signal by deinterleaving corresponding first decoding information; a channel decoder that generates channel decoding information by performing channel decoding of the deinterleaved signal; and an interleaver that generates feedback information by interleaving the channel decoding information, wherein the channel decoder outputs the channel decoding information after repeating decoding by the predetermined number of times as the second decoding information.

The channel decoder may determine whether to stop iteration of channel decoding based on reliability of the second decoding information.

The channel decoder may perform channel decoding by reflecting a decoding result of the third decoder.

The receiver may further include a parallel to serial converter that converts in series the plurality of second decoding information before performing multiple description decoding of the plurality of second decoding information.

Yet another embodiment of the present invention provides a method in which a transmitter transmits a signal using a multiple antenna, the method including: generating a plurality of descriptions by performing MDC of data;

forming the plurality of descriptions into a plurality of packets and outputting the plurality of packets in parallel; generating a plurality of first transmission information by performing channel encoding of each of the plurality of packets; converting the plurality of first transmission information to a plurality of second transmission information corresponding to the multiple antenna, respectively, based on the number of the multiple antenna; and transmitting the plurality of second transmission information using the multiple antenna.

The generating of a plurality of descriptions may include forming the data into the plurality of descriptions including related information.

The converting of the plurality of first transmission information may include aligning the plurality of first transmission information in series and then generating the plurality of second transmission information corresponding to the multiple antenna based on the plurality of first transmission information that is aligned in series.

Yet another embodiment of the present invention provides a method in which a receiver receives a signal from a transmitter, the method including: receiving the signal using at least one antenna; estimating a channel corresponding to the at least one antenna based on the received signal; generating decoding information corresponding to the received signal by repeatedly performing a decoding procedure including MIMO decoding and channel decoding based on the channel estimating value; and performing multiple description decoding of the decoding information.

The generating of decoding information may include performing the MIMO decoding that decodes an input signal in which feedback information is applied to the received signal based on the channel estimating value; and performing channel decoding of each of MIMO decoding results and repeating a process that generates the feedback information with a result of the channel decoding by one or more times and then generating decoding information by performing channel decoding of each of the MIMO decoding results.

The generating of decoding information may further include determining whether to stop iteration based on reliability of a result of the channel decoding and generating the decoding information.

The performing of multiple description decoding may include determining a quality of the decoding information including a description and performing multiple description decoding by selecting a description based on a determination result.

According to an exemplary embodiment of the present invention, a receiver can receive a signal regardless of channel environment and the number of receiving antennas and decode the received signal. Therefore, a transmitter can provide an optimal service to all receivers while efficiently using a radio resource.

### BRIEF DESCRIPTION OF THE DRAWINGS

FIG. 1 is a block diagram illustrating a configuration of a transmitter according to an exemplary embodiment of the present invention.

FIG. 2 is a block diagram illustrating a configuration of a receiver according to an exemplary embodiment of the present invention.

FIG. 3 is a flowchart illustrating a transmitting method according to an exemplary embodiment of the present invention.

FIG. 4 is a flowchart illustrating a receiving method according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification, unless explicitly described to the contrary, the word “comprise” and variations such as “comprises” or “comprising”, will be understood to imply the inclusion of stated elements but not the exclusion of any other elements.

Hereinafter, a transmitter and a method for transmitting MIMO and a receiver and method for receiving MIMO according to an exemplary embodiment of the present invention will be described in detail with reference to the drawings.

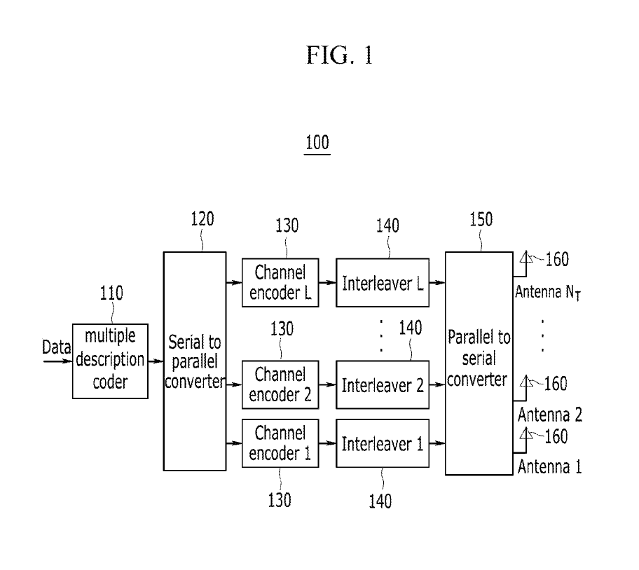

FIG. 1 is a block diagram illustrating a configuration of a transmitter according to an exemplary embodiment of the present invention.

Referring to FIG. 1, a transmitter 100 includes a multiple description coder 110, a serial to parallel converter 120, a plurality of channel encoder 130, a plurality of interleavers 140, a parallel to serial converter 150, and a plurality of transmitting antennas 160.

The multiple description coder 110 generates a plurality of descriptions by performing multiple description coding (MDC) of data. A MDC method is technology that divides one data into a plurality of descriptions and that encodes the plurality of descriptions, and the plurality of descriptions include related information. That is, the multiple description coder 110 forms original data into a plurality of descriptions, and in this case, the plurality of descriptions are expressed with different information but related to each other. Therefore, even if the receiver 200 does not receive some descriptions due to channel environment or the number of receiving antennas, the receiver 200 can decode original data based on a successfully received description.

The serial to parallel converter 120 outputs in parallel a plurality of descriptions that are output from the multiple description coder 110. The transmitter 100 performs channel coding of each of a plurality of descriptions that are output from the multiple description coder 110 and transmits the plurality of descriptions through different channels, and for this purpose, the serial to parallel converter 120 outputs in parallel a plurality of descriptions that are serially input. In this case, the serial to parallel converter 120 makes a plurality of packets corresponding to a plurality of descriptions, for example, the L number of packets (L is a natural number) and outputs the plurality of packets in parallel.

The plurality of channel encoders 130 correspond to a plurality of packets, respectively, that are transferred from the serial to parallel converter 120 and performs channel coding of a corresponding packet. The plurality of channel encoders 130 can perform channel coding of a packet to which a cyclic redundancy check (CRC) that can check an error of the packet in the receiver 200 is added.

The plurality of interleavers 140 correspond to a plurality of channel encoders 130, respectively, interleave an output signal of the corresponding channel encoder 130, and generate an interleaved signal. The plurality of interleavers 140 may interleave with different algorithm.

The parallel to serial converter 150 align in series the L number of signals that are input in parallel, then reconstructs the L number of signals to correspond to the number N_{T} of transmitting antennas, and generates a plurality of output signals corresponding to the plurality of transmitting antennas 160, respectively. In this case, the parallel to serial converter 150 receives in parallel the L number of signals in which each pilot for channel estimation of the receiver 200 is inserted.

The plurality of transmitting antennas 160 transmit a MIMO of a signal that is transferred from the parallel to serial converter 150.

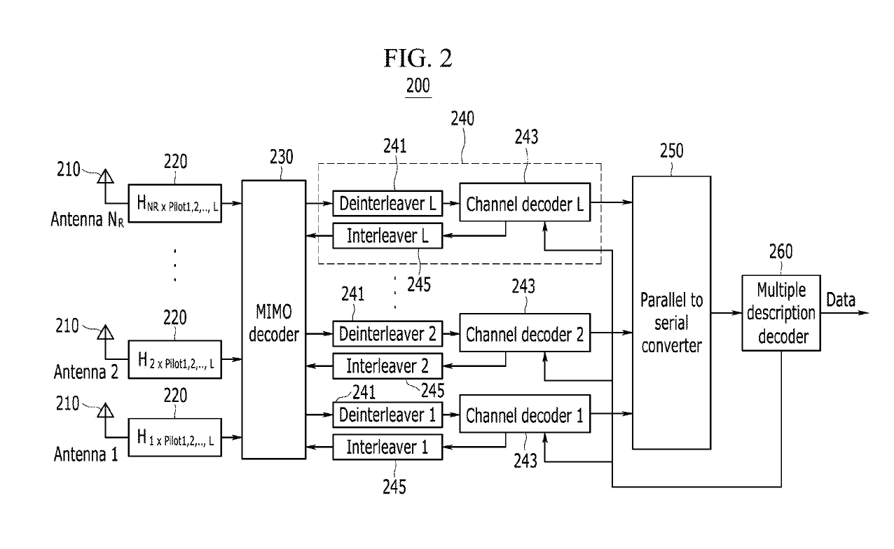

FIG. 2 is a block diagram illustrating a configuration of a receiver according to an exemplary embodiment of the present invention.

Referring to FIG. 2, the receiver 200 includes at least one receiving antenna 210, at least one channel estimator 220 corresponding to the receiving antenna 210, a MIMO decoder 230, a plurality of iteration decoders 240, a parallel to serial converter 250, and a multiple description decoder 260. The plurality of iteration decoders 240 correspond to signals, respectively, in which the MIMO decoder 230 transfers, and each iteration decoder 240 includes a deinterleaver 241, a channel decoder 243, and an interleaver 245.

The receiving antenna 210 receives a signal that is transmitted from the transmitter 100. In this case, at least one receiving antenna 210 may exist, and if a plurality of receiving antennas N_{R} 210 exist, the plurality of receiving antennas 210 operate with a MIMO method.

The channel estimator 220 estimates channel information of the corresponding antenna 210 based on a signal that receives through the corresponding antenna 210. The channel estimator 220 calculates channel information, i.e., a radio channel matrix using a pilot for channel estimation that is inserted in the transmitter 100. For example, when the transmitter 100 inserts and transmits the L number of pilots, the channel estimator 220 corresponding to a first antenna can obtain a radio channel matrix H_{1×Pilot1, 2, . . . L} using the L number of pilots.

The MIMO decoder 230 performs iterative MIMO decoding based on channel information of the receiving antenna 210. The MIMO decoder 230 transfers a decoding result to a plurality of iteration decoders 240. In this case, the MIMO decoder 230 generates a plurality of signals based on the number L of descriptions that are transmitted by the transmitter 100, transfers the plurality of signals to a plurality of corresponding iteration decoders 240, and generates and transfers the L number of signals to the maximum. The MIMO decoder 230 receives feedback information from the plurality of iteration decoders 240 and repeats a process of decoding the feedback information.

The plurality of iteration decoders 240 correspond to a plurality of signals, respectively that receive from the MIMO decoder 230, and each iteration decoder 240 performs channel decoding of the received signal, repeats a process of feeding back channel decoding information to the MIMO decoder 230, and outputs a final channel decoding result. For this purpose, each iteration decoder 240 includes a deinterleaver 241, a channel decoder 243, and an interleaver 245.

The deinterleaver 241 deinterleaves a signal that receives from the MIMO decoder 230, and the interleaver 245 interleaves output information of the channel decoder 243 and feeds back the output information to the MIMO decoder 230.

The channel decoder 243 repeatedly decodes while exchanging a decoding result with the MIMO decoder 230. Particularly, the channel decoder 243 receives an input of a soft decision from the MIMO decoder 230 and performs soft input soft output (SISO) decoding that outputs a soft decision decoding result. Particularly, the channel decoder 243 obtains reliability, which is an index for determining whether a decoding result is a value approaching original data by repeatedly performing decoding, and in this case, the channel decoder 243 uses an apriori probability or an aposteriori probability. The channel decoder 243 uses, for decoding, a log likelihood ratio that is obtained using the probability. In this way, the channel decoder 243 increases reliability of a decoding result by repeatedly performing decoding and may additionally obtain reliability of a decoding result by reflecting decoding information, for example, a multiple description decoding result or redundancy information of the multiple description decoder 260. Next, the channel decoder 243 repeatedly decodes by one or more times, then stops decoding, and determines whether to stop decoding based on reliability of a decoding result. Alternatively, when decoding is repeated by the predetermined number of times, the channel decoder 243 may complete decoding and adjust the number of iteration times according to a delay or power consumption of the receiver 200.

The parallel to serial converter 250 aligns in series signals that receive from a plurality of iteration decoders 240 and transfers the signals to the multiple description decoder 260. Particularly, because a signal in which the parallel to serial converter 250 receives from the iteration decoder 240 includes a description, the parallel to serial converter 250 transfers a plurality of descriptions to the multiple description decoder 260. In this case, the parallel to serial converter 250 may select a description having a good quality and transfer the description to the multiple description decoder 260. For example, the parallel to serial converter 250 may select a description based on a CRC that is inserted in the transmitter 100 and transfer the description to a serial stream.

The multiple description decoder (MD decoder) 260 combines and decodes an input plurality of descriptions. A plurality of descriptions are expressed with different information but are related to each other and thus can be decoded into a value approaching original data based on the input plurality of descriptions.

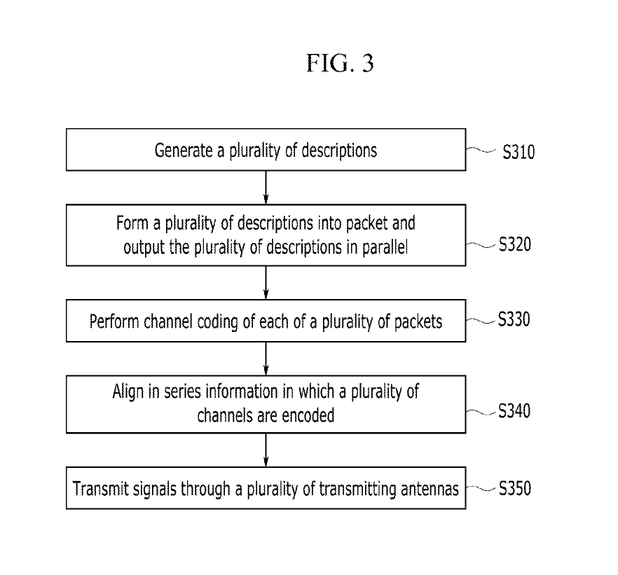

FIG. 3 is a flowchart illustrating a transmitting method according to an exemplary embodiment of the present invention.

Referring to FIG. 3, the transmitter 100 generates a plurality of descriptions by performing MDC of data to transmit (S310). The plurality of descriptions include information that is related to each other.

The transmitter 100 forms a plurality of descriptions into a packet and outputs the plurality of descriptions in parallel (S320). In order to transmit a plurality of descriptions through different channels, the transmitter 100 forms descriptions into a packet and outputs the description in parallel.

The transmitter 100 performs channel coding of each of a plurality of packets (S330). The transmitter 100 performs channel coding of a packet to which a CRC that can check an error of a packet in the receiver 200 is added. The transmitter 100 interleaves and transmits information in which each channel coding is performed. Additionally, the transmitter 100 may insert a pilot for channel estimation into each information in which channel coding is performed.

The transmitter 100 forms a plurality of information in which channel encoding is performed into signals corresponding to transmitting antennas, respectively (S340). The transmitter 100 aligns in series a plurality of information in which channel coding is performed, then reconstructs the information to correspond to the number of transmitting antennas, and generates a plurality of output signals corresponding to a plurality of transmitting antennas, respectively.

The transmitter 100 transmits the signals through a plurality of transmitting antennas (S350).

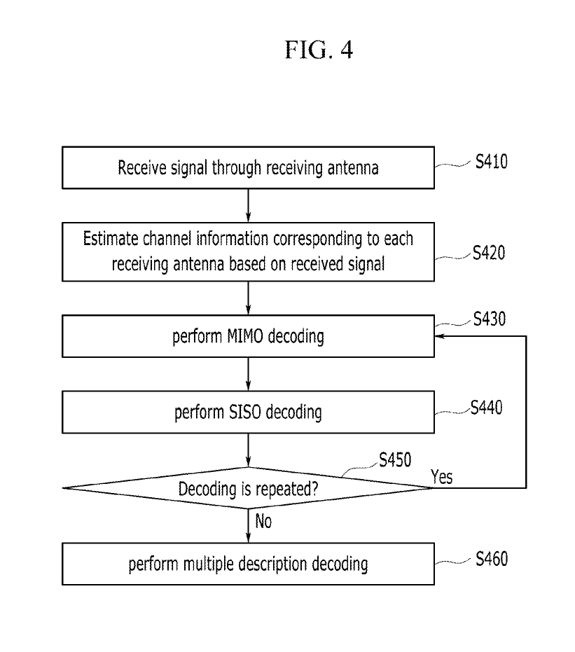

FIG. 4 is a flowchart illustrating a receiving method according to an exemplary embodiment of the present invention.

Referring to FIG. 4, the receiver 200 receives a signal through a receiving antenna (S410). In this case, at least one receiving antenna may exist. A received signal includes a description in which MDC is performed.

The receiver 200 estimates a channel corresponding to each receiving antenna based on the received signal (S420). The receiver 200 calculates radio channel information using pilots inserted in the transmitter 100.

The receiver 200 performs MIMO decoding based on channel information and an input signal (S430). In order to perform channel decoding of a description in which channel coding is individually performed, the receiver 200 generates a plurality of decoding information in which is MIMO decoded. The receiver 200 outputs a plurality of decoding information in parallel. In this case, the receiver 200 determines the number of decoding information to output in parallel based on the number of descriptions that are transmitted by the transmitter 100. The receiver 200 can know the number of descriptions through a received signal.

The receiver 200 performs channel decoding of each of a plurality of decoding information (S440). Particularly, the receiver 200 receives an input of a MIMO decoding result of a soft decision and performs SISO decoding that outputs a channel decoding result of a soft decision. For this purpose, the receiver 200 obtains a probability in which a channel decoding result approach original data and uses the probability for decoding.

The receiver 200 determines whether decoding is repeated (S450). The receiver 200 increases reliability of a decoding result by repeating MIMO decoding and SISO decoding. The receiver 200 determines whether to repeat decoding with various methods, for example, determines whether to repeat decoding according to whether decoding is repeated by the predetermined number of iteration times or according to whether reliability of a decoding result overpasses a reference value. Alternatively, the receiver 200 may flexibly adjust the number of iteration times according to a delay or power consumption. If decoding is repeated, the receiver 200 repeats MIMO decoding of step S430 by reflecting a SISO decoding result.

If decoding is not repeated, the receiver 200 completes decoding and decodes a multiple description based on a final SISO decoding result (S460). The receiver 200 combines and decodes a plurality of descriptions that are included in the final SISO decoding result. In this case, the receiver 200 can select and decode a description having a good quality and determine a quality of a description based on a CRC that is inserted in the transmitter 100.

In this way, according to an exemplary embodiment of the present invention, the receiver 200 can receive a signal regardless of channel environment and the number of receiving antennas and decode the received signal. The transmitter 100 can provide an optimal service to all receivers while efficiently using a radio resource.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A transmitter that transmits data using a multiple antenna, the transmitter comprising:
a multiple description coder that generates a plurality of descriptions by performing multiple description coding (MDC) of the data; and
a multiple input multiple output (MIMO) transmitting unit that performs channel coding of the plurality of descriptions and that transmits the plurality of descriptions in which channel coding is performed through the multiple antenna.

2. The transmitter of claim 1, wherein the multiple description coder forms the data into the plurality of descriptions comprising related information.

3. The transmitter of claim 1, wherein the MIMO transmitting unit comprises
a serial to parallel converter that forms the plurality of descriptions into a plurality of packets and that outputs the plurality of packets in parallel;
a plurality of channel encoders that correspond to the plurality of packets, respectively, and that generate a plurality of first transmission information by performing channel coding of each of the plurality of packets;
a parallel to serial converter that converts the plurality of first transmission information to a plurality of second transmission information corresponding to the multiple antenna, respectively, based on the number of the antennas included in the multiple antenna; and
the multiple antenna that transmits the plurality of second transmission information.

4. The transmitter of claim 3, wherein the serial to parallel converter determines the number of the packets based on the plurality of descriptions and information of the channel encoder.

5. The transmitter of claim 3, wherein the parallel to serial converter aligns in series the plurality of first transmission information and then generates the plurality of second transmission information corresponding to the multiple antenna based on the plurality of first transmission information that is aligned in series.

6. The transmitter of claim 3, further comprising a plurality of interleavers that interleave the plurality of first transmission information, respectively, before converting the plurality of first transmission information to the plurality of second transmission information.

7. A receiver that receives a signal that is transmitted from a transmitter using at least one antenna, the receiver comprising:
a channel estimator that estimates a channel corresponding to the at least one antenna based on a received signal;
a first decoder that generates a plurality of first decoding information by performing MIMO decoding of an input signal in which feedback information is applied to the received signal based on a channel estimating value;
a plurality of second decoders that perform channel decoding of the plurality of first decoding information, respectively, and that repeat a process that generates the feedback information with a result of the channel decoding by one or more times and that then generate a plurality of second decoding information by performing channel decoding of the plurality of first decoding information, respectively; and
a third decoder that performs multiple description decoding of the plurality of second decoding information.

8. The receiver of claim 7, wherein the first decoder determines the number of the plurality of first decoding information based on the number of descriptions that are included in the received signal.

9. The receiver of claim 7, wherein the second decoder comprises
a deinterleaver that generates a deinterleaved signal by deinterleaving corresponding first decoding information;
a channel decoder that generates channel decoding information by performing channel decoding of the deinterleaved signal; and
an interleaver that generates feedback information by interleaving the channel decoding information,
wherein the channel decoder outputs the channel decoding information after repeating decoding by one or more times as the second decoding information.

10. The receiver of claim 9, wherein the channel decoder determines whether to stop iteration of channel decoding based on reliability of the second decoding information.

11. The receiver of claim 9, wherein the channel decoder performs channel decoding by reflecting a decoding result of the third decoder.

12. The receiver of claim 7, further comprising a parallel to serial converter that converts in series the plurality of second decoding information before performing multiple description decoding of the plurality of second decoding information.

13. A method in which a transmitter transmits a signal using a multiple antenna, the method comprising:
generating a plurality of descriptions by performing multiple description coding of data;
forming the plurality of descriptions into a plurality of packets and outputting the plurality of packets in parallel;
generating a plurality of first transmission information by performing channel encoding of each of the plurality of packets;
converting the plurality of first transmission information to a plurality of second transmission information corresponding to the multiple antenna, respectively, based on the number of the multiple antenna; and
transmitting the plurality of second transmission information using the multiple antenna.

14. The method of claim 13, wherein the generating of a plurality of descriptions comprises forming the data into the plurality of descriptions including related information.

15. The method of claim 13, wherein the converting of the plurality of first transmission information comprises aligning the plurality of first transmission information in series and then generating the plurality of second transmission information corresponding to the multiple antenna based on the plurality of first transmission information that is aligned in series.

16. A method in which a receiver receives a signal from a transmitter, the method comprising:
receiving the signal using at least one antenna;
estimating a channel corresponding to the at least one antenna based on the received signal;
generating decoding information corresponding to the received signal by repeatedly performing a decoding procedure including MIMO decoding and channel decoding based on the channel estimating value; and
performing multiple description decoding of the decoding information.

17. The method of claim 16, wherein the generating of decoding information comprises
performing the MIMO decoding that decodes an input signal in which feedback information is applied to the received signal based on the channel estimating value; and
performing channel decoding of each of MIMO decoding results, repeating a process that generates the feedback information with a result of the channel decoding by one or more times, and then generating decoding information by performing channel decoding of each of the MIMO decoding results.

18. The method of claim 17, wherein the generating of decoding information further comprises determining whether to stop iteration based on reliability of a result of the channel decoding and generating the decoding information.

19. The method of claim 17, wherein the performing of multiple description decoding comprises determining a quality of the decoding information including a description and performing multiple description decoding by selecting a description based on a determination result.
